(19) United States
(12) Patent Application Publication
(10) Pub. No.: US 2013/0132415 A1
(43) Pub. Date: May 23, 2013

(54) System and Method to Improve Communication Between Virtual Objects

(71) Applicant: Bruce W. Adams, West Vancouver (CA)

(72) Inventor: Bruce W. Adams, West Vancouver (CA)

(21) Appl. No.: 13/679,356

(22) Filed: Nov. 16, 2012

Related U.S. Application Data
(60) Provisional application No. 61/561,073, filed on Nov. 17, 2011.

(51) Int. Cl. G06F 17/30

(52) U.S. Cl. CPC G06F 17/30979
USPC 707/758

(57) ABSTRACT

The present invention provides a system and method to improve virtual object communication. This is dependent on a method of comparing data sets, characterising data according to its use, for rapid assessment of the correlation between data sets, especially as used to correlate human emotional needs in interpreting data.

### CROSS-REFERENCE TO RELATED APPLICATIONS

This application claims benefit under 35 U.S.C. 119(e) to U.S. provisional patent application Ser. No. 61/561,073, filed Nov. 17, 2011, which is incorporated herein by reference in its entirety.

### FIELD OF THE INVENTION

The present invention pertains to the field of internee communications and in particular to correlation of data to improve communications outcomes.

### BACKGROUND

Individuals use the internet to search for information, communicate with friends and family, form social networks, and entertain themselves with a plethora of multimedia and interactive applications. Businesses rely on the internet to manage information and extend global communication, as well as market products and services. Although the internet has become integral in both business and personal contexts, new applications need to demonstrate the ability to extend computing experiences and user interfaces. This is especially important to businesses competing to attract new clients within the ever-changing digital landscape of global e-commerce.

Therefore there is a need for improved communications between people and subjects in the internee environment.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method to improve virtual object communication. In accordance with an aspect of the present invention, there is provided a method of comparing data sets comprising selectively characterising data according to its use, such that a third party can interpret such data by comparing it to an expected normal state, or to preferred characteristics of a second or nth data set, whereby the methods of reducing data to be represented by an equation to allow for rapid assessment of the correlation between data sets, especially as used to correlate human emotional needs in interpreting data.

In accordance with another aspect of the present invention, there is provided a method of comparing data sets whereby interpretation of a correlation between data sets can be optimized to enable a display that represents a pattern that can be recognized by a person, or by machine analysis such as a bar code, designed to enhance the communication between people and objects.

### BRIEF DESCRIPTION OF THE FIGURES

FIG. 1 illustrates Inputs, Classification & Relationships of a data input survey.

FIG. 2 illustrates a third order equation for a polynomial representing a five point data set.

FIG. 3 illustrates a three dimensional surface z=f(x,y), that represents the difference between two data sets, and boundary area of specific focus, represented by a Taylor approximation near a point (x₀, y₀).

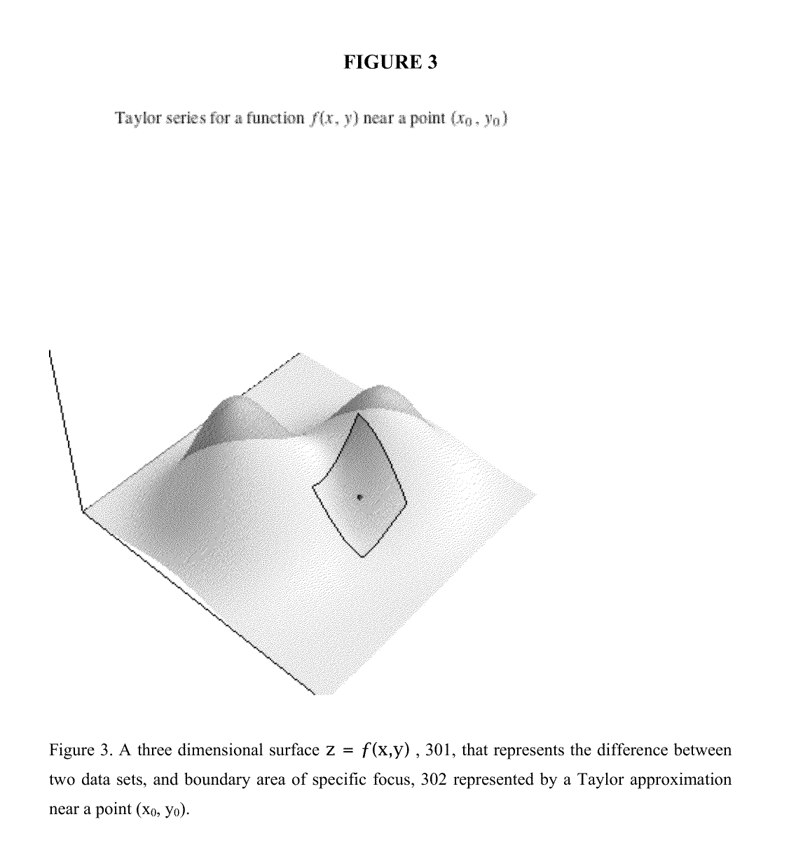

FIG. 4 illustrates graphic visualization of a quadratic surface from an equation of the form z=x̂2−xy+ŷ2.

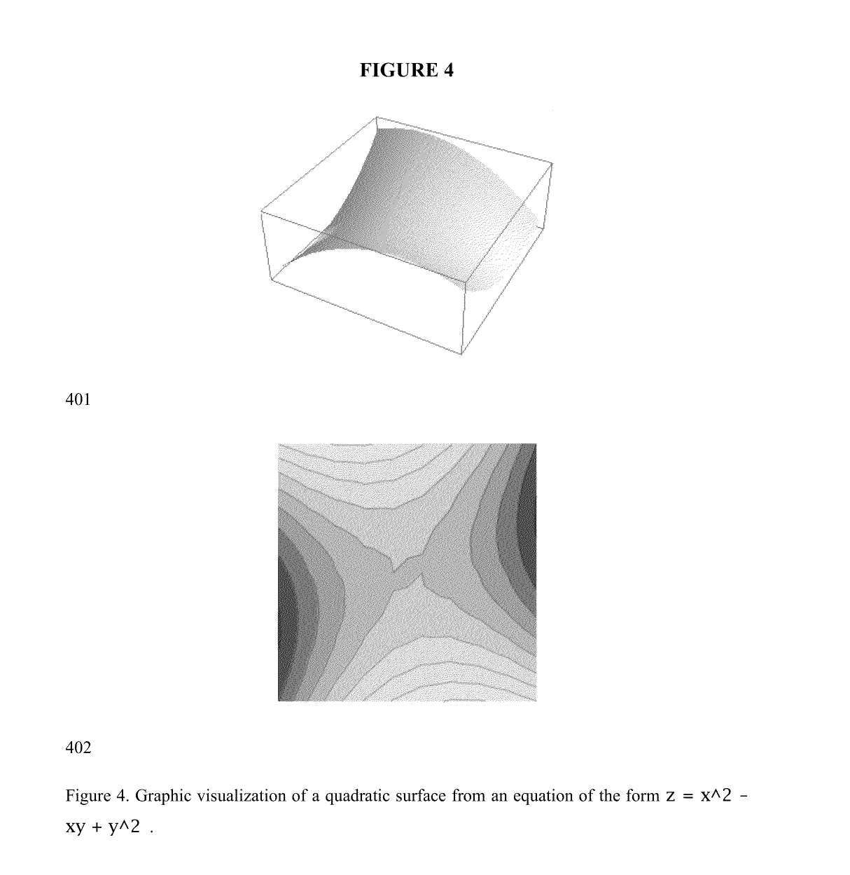

FIG. 5 illustrates polynomial fitting to a data set showing short term differences in fit of a polynomial from third order down, the third order by itself, and the higher correlation of fit in a longer time domain at the same sample rate.

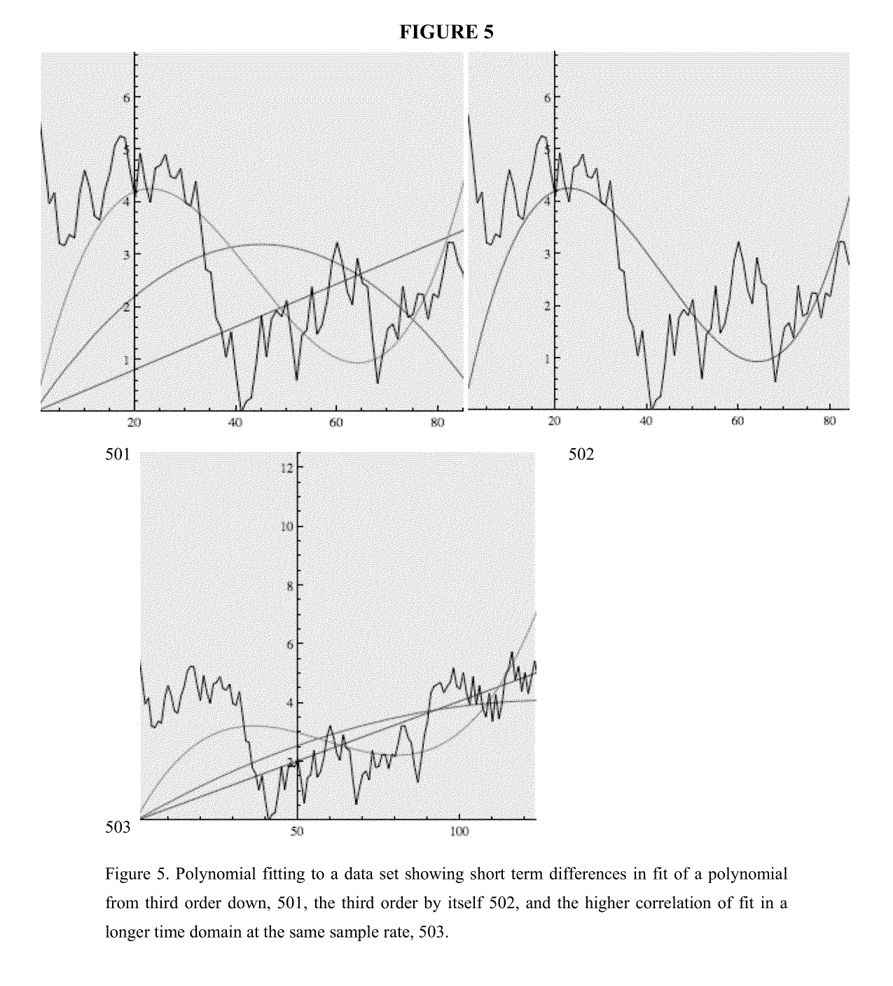

FIG. 6 illustrates examples of plots that can represent an algorithm, that typically uses an expression R(x,y)=|f(x)−f(y)| of a recurrence plot.

FIG. 7 illustrates graphs of decision points, for a simple decision, complex decision, and indeterminate decision.

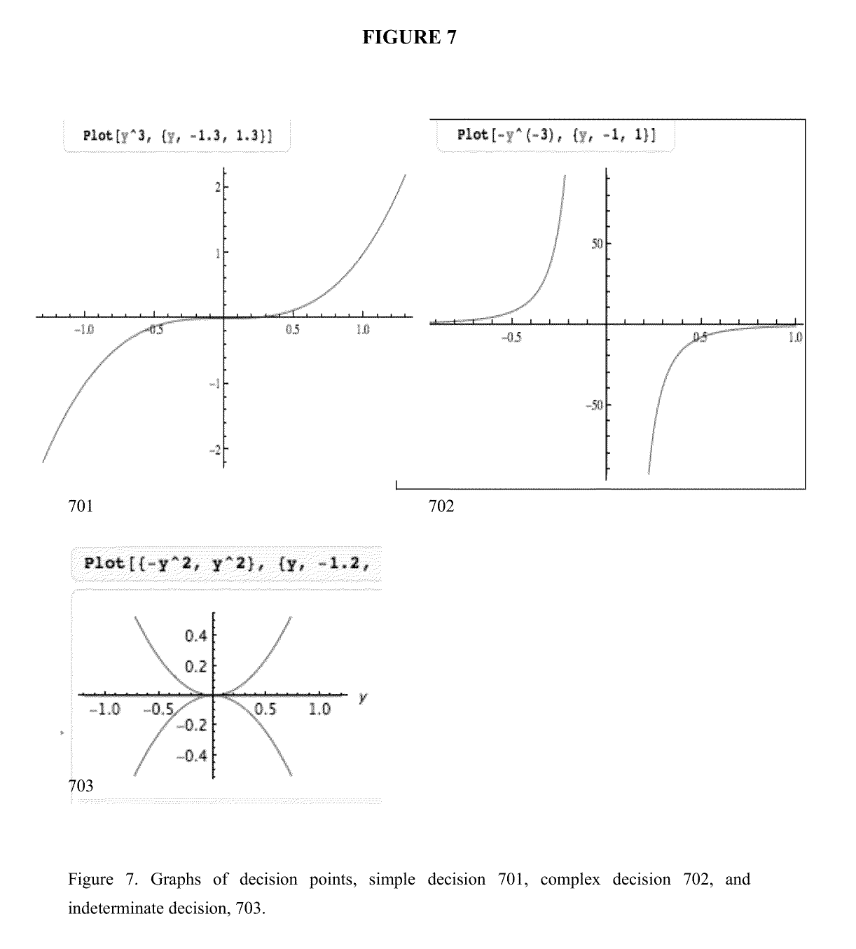

FIG. 8 illustrates virtual object, which is characterized by its continuous generation of questions and answers, modified by its response history.

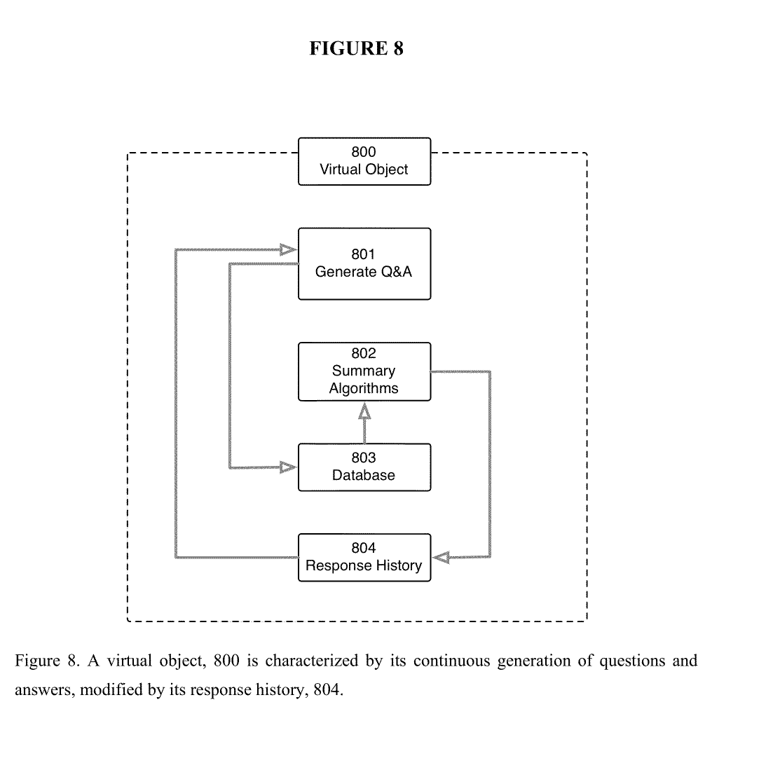

FIG. 9 illustrates a virtual object space and its computing environment.

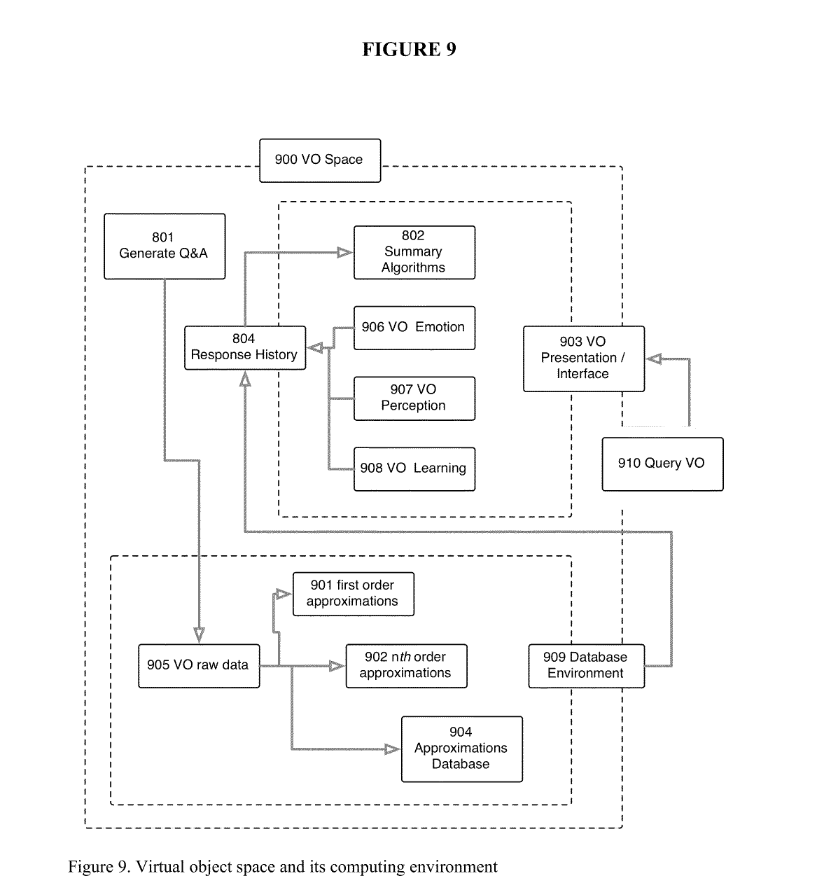

FIG. 10 illustrates an environment for human context decision processing.

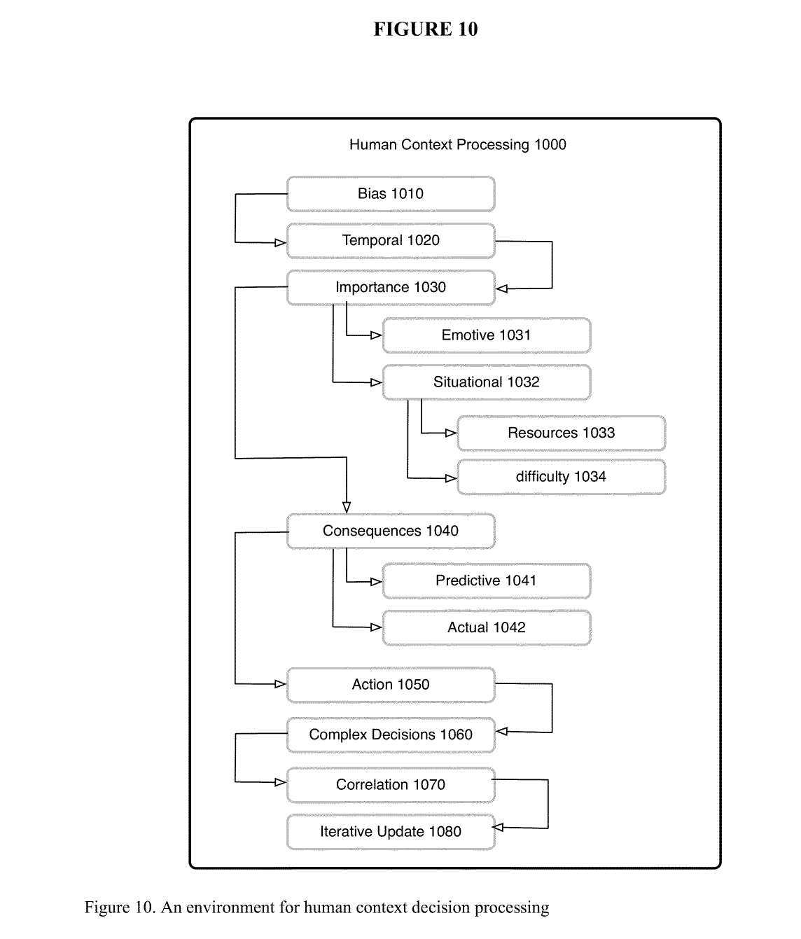

### DETAILED DESCRIPTION OF THE INVENTION

Definitions

The term “virtual object or VO” is used to define an object such as similar to a cyberhuman or cyberobject but existing primarily to allow for entity features such as communications and management of data including but not limited to social media, information research, news filtering, shopping and other matters in the internet environment.

The term “virtual object space or VO space ” is used to define the computational models of a VO and their related data sets.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides a virtual object 800, VO space and computational method including an input means and output means. It is designed to be a network based technology using the global network of existing relationships, such as the internet. Humans form long term social relationships with each other, and computer entities can be designed to enhance these. These relationships can be enabled by a synthetic persona or digital entities, to manage an individuals online relationships, whether these are personal relationships between friends, or between social groups, or between humans and the synthetic persona of non human entities such as products, or companies, or between humans, or between non-human entities. These synthetic personas or virtual objects (VO's) can be the basis of social relationships or business relationships. The behavior patterns between certain VO's can allow for interactive components, such as changes based in its response history 804, to be memorized and edited and would allow people and their objects to project rich emotions into their potential and actual online relationships. More and more, computer systems are able to participate in social relationships of the kind that people and animals form. They can enhance the benefits of sociality among groups, and engage people with some aspects of the richness that we expect from natural social entities, especially where a question and answer process can represent an accelerated learning environment 903 that makes people more comfortable with information, and not increase their apprehension to unknown data. As such the method herein described uses an interface to such data to allow for common features that are easily understood to be presented as first facts, and more in depth information to be presented and follow on information, and these skewed to the apriori knowledge of the questioner.

One goal of the invention is to create a simple system through which VO's may form social relationships that resemble those formed by people. In addition, the system makes it possible for people to participate in and direct those relationships. A social relationship methodology for computational VO's could help form the basis for a wide variety of applications in computing and its interactions with humanity. A social relationship has several clear attributes; it is learned during an individual's lifetime, rather than genetically; it changes continually during this time based on the ongoing interaction history between the individual and its social partner; and it is closely linked with emotion, both in its formation and in its expression. The computational VO model of this invention accounts for each of these attributes, incorporating simple models of emotion, perception and learning. Another goal is that the VO mechanism for formation and maintenance of multiple synthetic social relationships, where an emotion-based characteristics of natural social relationship mechanism has been applied in an interactive domain, thereby allowing people to participate in the relationships and add interpretive, reflexive and iterative components 804. Typically humans try to apply interpersonal social skills to the technology around them and it can be frustrating when the machines do not react in kind. One aspect of the invention is to have VO profiles that define the user and better enable data to be presented in an appropriate manner to enhance participation, 802. Social relationships will increase the functionality of groups of computational VO's as human social relationships are one of the main reasons that people embrace technology.

Therefore one objective of the invention is to provide a mixture of templates for customization to create internet VO's. Each VO has attributes that are similar to personalities, habits, capabilities. Relationships are created to connect entities in order to describe the connections that could exist and templates & simulations can be assigned for building entities. In one embodiment, an entity has a user interface 801 that allows access to the VO owner, including forms and surveys; that allows access to interact between entities; a rule based system that identifies the owner and the scope of a VO's potential interactions, that enhances VO status by its use and patterns and online experience and that allows for VO's to exchange relevant information on each other and form groups and connections.

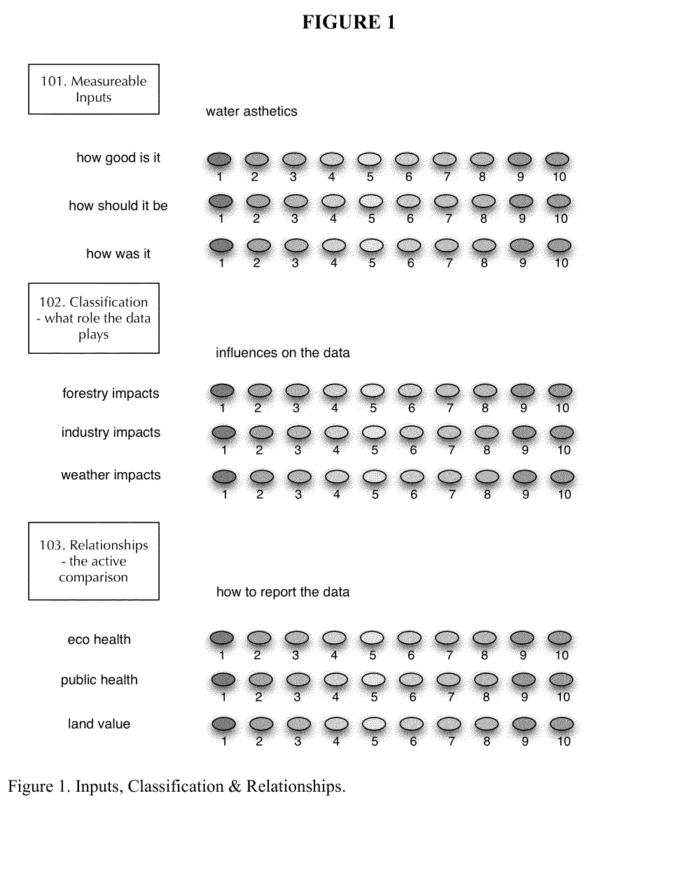

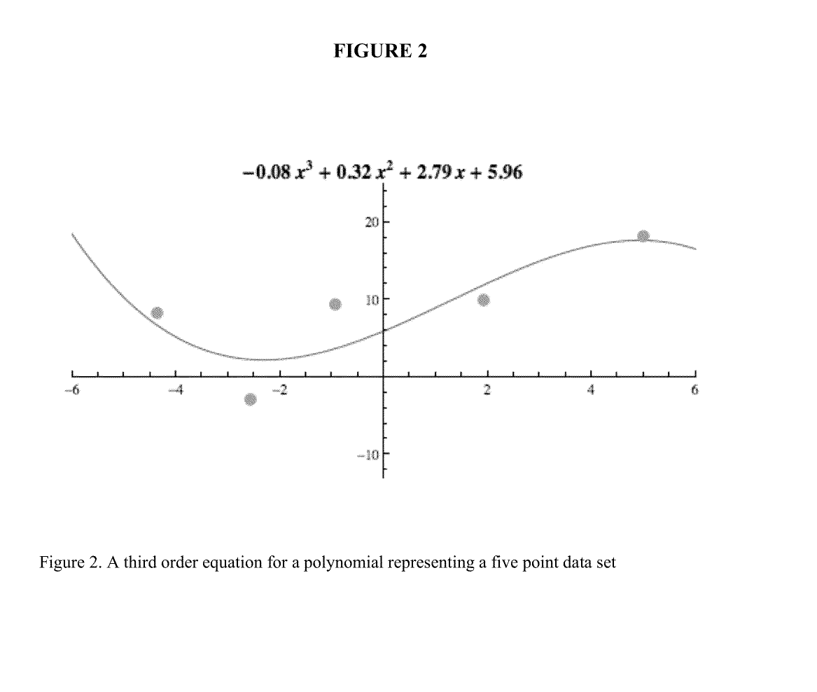

VO's can have unlimited social media connection capability and allow these to be tracked and have the capability to reference human behavior and suggest how certain relationships can be achieved, and monitored. VO's can communicate by comparing logical patterns some of which are the type which are described in conventional event analysis, such as the EN 61025: 2007 fault tree analysis standard which defines basic principles, provides the steps necessary to perform an analysis, identifies appropriate assumptions, events and failure modes, and provides identification rules and symbols. Such conventional analysis is performed and presented as variations to a baseline standard. However, with the methods used herein, data is screened and presented by way of the query preferences, with steps that involve high level rapid comparison, including principal component analysis data compression techniques designed to allow rapid query and correlation to a variable baseline as determined by the VO that makes the query, and comparison to a conventional baseline standard. The VO entity features can be described compared to a baseline standard, but searched based on the query baseline preferences. A VO data set might be created in a survey environment, FIG. 1. This would include the elements of measurable inputs, 101, a classification of the data, 102, and the relationship of the parties involved, 103. The discrimination of events from a VO dataset can be its simplest form such as a yes/no response to a question or can be the convolution of data and its subsequent correlation as might be achieved with a 2D polynomial, FIG. 2, or with an algorithm that whose product is a 3D spatial display of surface intersection or comparison, 301.

In one embodiment, fitting of a forth order polynomial to a data set is used to create a baseline by which multiple similar data sets can be compared quickly. The highest order represents those detailed issues that are most critical to a comparison, and the lower orders can represent those detailed issues that can be represented as trends less important to comparison.

Other data sets such as lines, surfaces, and shapes can be used. A surface can be a single minimal surface and a best functional form is a bounded variation, 302, especially where approximate details of expected or desired outcomes are predetermined. This is the case where objects have unique positions in the hierarchy of how they relate; in a defined space; to each other; and to a human or group. An object can minimally meet best fit requirements but still be the best fit available in a group of options. In this context, a small change in an object can make a significant difference in how it relates to another object, if the change is in context within a predefined bounded variation.

In human to human communication, the comparison of certain trends may be more important than details and in a time series the trends can be compared, facilitating even faster response times in data analysis. In multidimensional data, a series of polynomials can represent diverse data sets or define surfaces. A quadratic surface, 401, of the form z=ax̂2−bxy+cŷ2 can be used to characterize the pattern, 402, of how data compares to a normal or expected result and additional forms of surface creation can be used such bezier spline surfaces, or surfaces defined by multi order polynomials or by the surface creation by using curves or a series of points as defining parameters such as with a de Casteljau algorithm, and the surface can be the tensor product of those curves. Similarly, a spherical shape can be used to define one entity and the shape and volume of the intersection between this and other shapes be used to interpret which data points are best characterized in communication. One embodiment of the system will represent the relationship between two objects as a shape. The process is divided into stages where a first stage is to represent data into a primitive representation of the relationship between virtual objects, and this represents a primary source of information for all later stages. A complex shape is an example of a later stage of such a representation.

An area analysis of the surface, such as might be defined by z=f(x,y) can be made using a Taylor approximation, 301. Such area specific analysis would allow data comparison of limited form such as would be ideal in assessment of complex parameters, yet allowing a personal focus on certain predefined elements which can be correlated to (x,y) coordinates in cartesian space and further used in a time series analysis. These applications enable a heuristic and modular approach, especially allowing a computer interface to improve intuitiveness and allow for emphasis of particular features, such as polynomial fits fx=(x,y) versus fx=(x̂n,y), and to plot this information in a form that would enable a pattern, 402, that would be universally understood without any actual knowledge of the specific data that had changed. Such patterns could be displayed on a personal computer, or mobile device and help a person to determine when to look at specific data, enabling the power of human cognition in data and event analysis without ever having to look specifically at the data.

Virtual Objects

In one embodiment of the invention, virtual objects 800 are characterised by their input means 801, where a question and answer environment is created to allow for generation of best answers to queries such as important, popular and operational questions, or to query standards as defined in best practices. Additionally, the computations in the virtual object space, 900, and the summary algorithms, 802, define the response history 804, creating an iterative environment to the data input.

Virtual Object Space

The VO space, 900, and its computational database, 909, and presentation layer 903, provide an opportunity for queries, 910, to connect to the presentation interface 903, where the query is associated with VO emotion 906, VO perception 907, and VO learning 908, together with the database environment 909, defining the response history 804, and summary algorithms 802. The database environment 909, allows for updates from the response history to enhance the query specific criteria for first order, 901 and nth order, 902, approximations, including updates to the approximations database which include query memory. Together with the raw data 905, all of these features can serve to improve query speed, accuracy and enhance the human aspect of the query experience.

Isolation of Information

Constraints can use information without verification in a first pass analysis. This will further reduce the impacts on computational power if the first pass analysis does not have to satisfy the constraint and can assume it is true. Ultimately poor data should not prevent results being presented but can result in an adjustable confidence measure. In the case of a virtual object, the areas of focus would be the deviations from normal patterns in the area of interest. Convolutions are computationally expensive and therefore it is ideal to reduce their number and dimension. This can be achieved by compressing the values of the data based on virtual object preferences, and allowing these prioritized sets to be searched before the raw data is searched. Correlation to an ideal is one way of normalizing data and as such presenting data. Uniqueness based on limited detailed feature analysis and overall correlation to a total feature set is one way for novelty to stand out in a summary of VO features that otherwise match an ideal criteria or data range in a compressed form. The continuity of how VO features whether specific or compressed, meet prior convolved representations over time is another way to match filter a data set. A normalized data set has the advantage of being faster to search for context specific information.

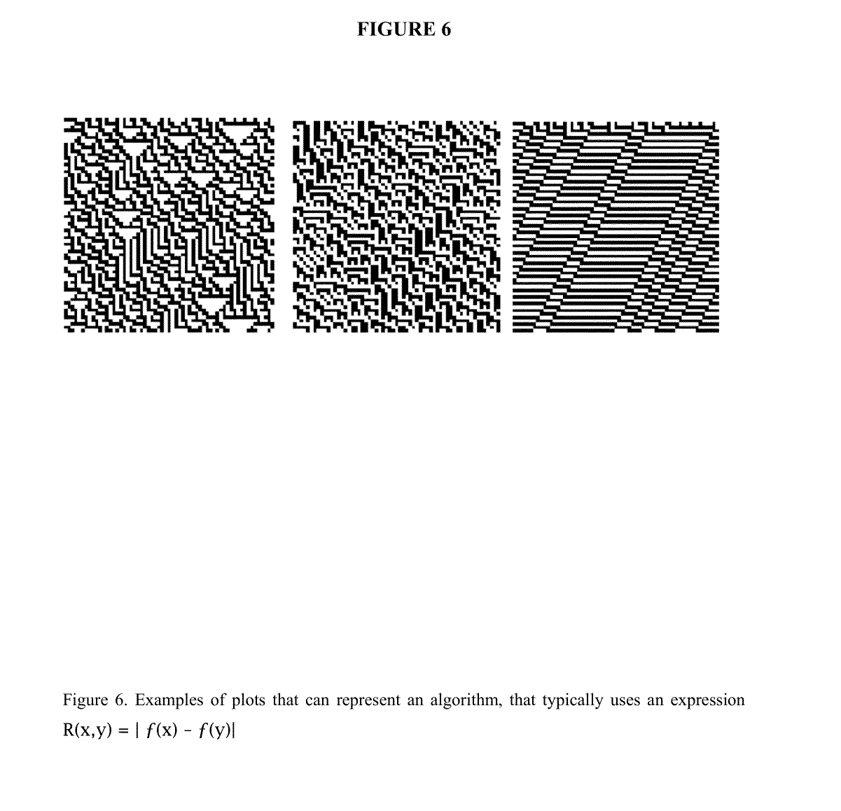

Modeling a data set as a polynomial or a series of polynomials, 501, can describe a data set based on its exponential order such as a third order or forth order polynomial, further allowing for emphasis to be placed on certain matching criteria. Further modeling a data set such as a primitive surface allows any point to be located by its (x,y) coordinates and a variation as a deviation from that allowing complex multi dimensional data sets to be represented by their correspondence to a polynomial. In this case, what would be considered heuristic methods of human analysis, for instance, common sense, can be represented quickly in clustering algorithms. Such a process would represent data in a surface model where cluster values are the result of the sum of the squared euclidian distances of the members of the clusters from their centroid, and can be expressed in terms of the distances between individual cluster centroids and further allowing the system to search for individual cluster values rather than all values. This is particularly important for hyper dimensional data where clustering can rapidly outperform human visual classification of data, and representation of the clusters by polynomials can allow for variations in data to be quickly noted allowing for rapid visual display such as with a integral convolution. Such a computational format could allow for cellular automation calculations to display a 2D graphic which would be the equivalent to a correlation bar code on a product label, indicating the product characteristics compared to normal, allowing shoppers to quickly scan products for their distinctive character, such as with a recurrence plot, FIG. 6. One significant difference to existing barcode technology is that the invention will have as a visual output, a 2D or 3D graphic that can be easily recognized by a person and a scanner, while the present are barcodes do not enhance human recognition.

Clustering of data prior to polynomial fitting could also result in assigning priority to certain clusters and allowing for rapid convolution of the most important data only, effectively match filtering by looking at the critical aspects of a function that represents a 2D representation, and further allowing for extraction of critical data only. This might be useful for retail buyers and sellers to match criteria, such as rapid interpretation of product characteristics and its suitability to be used in conjunction with a set of predetermined criteria. Correlation of a real time data set can also be managed by clusters of data that allow for matching of search criteria to a variable data stream. In many data sets ambient or seasonal conditions can change the baseline normalization functions and these can also be driven by known conditions outside of what is considered normal. In this case, key relationships can be preserved and events can be extracted from the perspective of variable criteria, in a series of “what if?” scenarios, where multiple correlations can be made to maintain sensitivity to small events. This would also be useful in preventing overwhelming event messages that would not be important in other contexts, such as number of events in a certain period, where actions had already been taken to resolve or manage the consequences of an event, or where the frequency of small events was a determinant instead of the alarm threshold of events.

With any of the prior examples of data comparison, a role may be associated with the data. Typically, roles that humans take on will have different prioritization between people, based on their personal requirements for context or duties. For instance, this would be the case in hierarchal structures in a workplace or in an unstructured environment where data could be more effectively presented if in some context. The roles of data in a comparison where one aspect is given different priority than another can quickly change the priority in algorithm comparison by emphasizing the most important facts in a relationship and allowing for more detailed analysis at a later time. This will accommodate diverse levels of usability, technical understanding, and user trust. Multiple methods of analysis can be made with a standardized interface that manages key areas of a relationship over time, an interface with more complex comparison of virtual objects, and iterative interface that explores questions and scenarios within a data set.

High Performing Virtual Objects

People whose online presence can be validated by their real world presence tend to be stronger hubs in networks. There is a sense of knowing public figures that validates the honesty of an online profile. However, many non-public figures have need to validate their profiles in order to provide assurance that information is not being prepared in a deceptive manner. Honest communication that conveys the best possible impression is more effective when validated. Proofs of identity and intention improve the potential for high level interaction. Traditionally this validation can be expensive in terms of time and effort. Peer review is a form of validation where publishing into papers with accepted standards is required to get career movement. A VO based comparison of features of a persons profile can be used and validated by others in various forms, including online rating such as Amazon.com or with employers and personal connections such as with LinkedIn.com, or with connections to certain publications. These scenarios typically do not allow for rapid assessment of the validity of connections however, an object classification system would allow certain types of objects to be related to in a database. For instance, a physical object, person or system could be classified in its virtual object space by its history, volume, cost, esthetics, performance and other standard measurable characteristics. These could be assigned by agreed to experts in the same manner for instance as Wikipedia, allows people to contribute. A VO might be validated further by patents, business connections, personal connections, government ID and so on, and all forms of validation could be used to measure the legitimacy of VO and this data combined can be further simplified to be represented as a polynomial, surface or shape that lends itself to comparison.

One object is to provide a synopsis of the complex dimensions that human reasoning would accomplish. For humans to interact with the multi-dimensional data, this data must be presented in a form that can be viewed, but also in a context that can be interpreted. Familiarity with the data presentation allows for a more rapid cognitive association. To present data in a visual form, multi-dimensional data must be represented as a two dimensional form, with the added benefit of color and shape manipulation. The computational paradigms are well known as are the basic tenets of human computations of symbolic representations of visual information. As a consequence, people can distinguish between abstract computations and the meaning of symbols and language embedded into representations.

Emotional Data

One embodiment of the invention requests human emotional data, 906, as part of a question and answer process. There are various known models of human emotion. One such emotional model is known as the OCC model, where the consequences of events, the actions of agents and the perception, 907, of an object can be classified. An event aimed at realizing a particular objective could create joy; an action from an query that would go against his principles could end up with a feeling of shame, and so on, depending on the agent preferences. The OCC model defines three classes of emotions, according to the emotional context they refer to. Each emotional dimension is represented by an antagonistic couple, like joy and distress, or love and hate, in which an individual's emotional state is located, somewhere between the two bounds.

One aspect of the invention is to consider these three classes of action and response as the inputs to a three dimensional environment so that relationships can be modeled as emotional object, or a class of virtual objects which could used for enhanced communication. Accordingly, the axis are: event consequences; actions of participants; common perceptions all within a learning environment, 908.

The personality of a VO can be established by its owner using multi-dimensional representation of its characteristics, for instance its human emotions, or capacity to elicit such emotions. Such characterization would allow VO's to quickly determine if they wished to communicate and find consensus with information. Presentation of information in context with human emotions can improve communications and learning and further motivate decisions and actions.

Communication between people could be considered as weighted and non euclidian, especially in context where there are distinct preferences, objectives, opinions, and points of view. For instance a proposition in human to human communication can be considered true or false or ‘something else’ and differently by each person. This can be modeled in a computational system where each person, represented as a VO can have certain preferences in weighting certain values and can thus interpret the value of, for instance, the answer to a certain question. In such a case a VO person may represent itself as having the answers to a number of questions, the answers which describe the relationship that real person has with his/her environment. This would be useful where a real person does not have sufficient time to communicate in person with many thousands of people in a virtual network, or with standard methods of social media such as Twitter, Facebook and email. Rather the person would enable such dialogue by a one time question and answer methodology, perhaps answering hundreds of questions, in certain categories, and enabling a different VO or VO person to access the answers by asking a series of questions to the VO, providing a high level of interaction, to specific details as the questioner might understand by prior knowledge, or familiarity with the real person, yet wishing to follow the actions of that person. Examples of this might be a scientist who is following a research track that may take many years to develop, and may only periodically make updates, however, the query between VO's can remain active for virtually any length of time. Another example might include a company that wishes to communicate with its shareholders and can prepare a list of typical questions that might for instance be asked at an AGM or other meeting.

In these cases probability or assertion of some correlation can be made based on a reaction convolution where probability of correlation between two or more polynomials can be based on what is believed, asserted or verified. A proposition can be given probability values if: believed, doubted, disbelieved; asserted, considered, rejected; verified, not verified, refuted. A series of questions may provide a series of logical and consistent answers from the answering VO, yet these answers may prove to be illogical or inconsistent with the questioning VO depending on the context in which they are interpreted. All these models may be further equated with their relative likelihood. One way of equating human response is to weigh the factors as might be considered negative, and then weigh the factors that might be considered positive. As time progresses the scale of the negatives can weighted by the experience of the individual, the combination of circumstances and the time needs to access. When a critical decision is made the weighting of the positive factors can be considered in context with the decision. In this case fx=ŷ3 where a decision is complex yet easier over time 701, or fx=−1/ŷ3 where a decision is more complex over time but reaches a critical point 702, or fx=(−ŷ2, ŷ2), an indeterminate decision.

A human to human logical communication process demands consideration of various parameters including changes with experience and time, familiarity with the questions and with the people involved. Personality traits are notably missing in present art communication, and efforts to reflect mood in an iterative communication can often be lost. This is a common factor in shared email threads. Emotionally charged communication described by such as Negatives: Restlessness, Apprehension, Disquiet, Dread, Worry, Misgiving, Foreboding, Uneasiness, Concern; and Positives: Assurance, Calmness, Composure, Confidence, Security, Quietude, Equanimity. It is one objective to enable people to equate their questions with their priorities in a timeline, where the expectation of that timeline is correlated to the emotional outcome.

An Integrated Approach to Combining Human Context and Internet Capabilities

One embodiment of the invention is an implementation of an algorithm that imbeds the equations in series such as: Bias 1010, where the observational bias can be based on the response history 804, can be a product of emotive inputs 906, perception 907 and learning 908. Temporal 1020, where a sequence of events related to a decision including the frequency, duration, amplitude and can be represented in summary algorithms or equations 802, in reference to apriori bias. Importance 1030 where the correlation of equations such as n^{th} order approximations 902 in approximation database 904 can be used to simulate in a query/presentation interface 903, including emotive correlation 1031 and availability or situational correlation 1032 with such factors as resources 1033 and such as the ability to implement or execute based on situational complexity and difficulty 1034, such complexity as may provide both opportunity and risk. Consequences 1040 represented by impacts of a decision, can be recorded 804 and used for simulation of the risks of making or not making a decision and presented in a presentation interface such as: predictive consequences 1041 or those based on apriori knowledge and actual consequences 1042 or real time or timely updates. Actions 1050 to be taken as would be typical in a question and answer decision process 801, especially in an automated VO environment or VO to human environment, and could be presented as the product of eigenvectors of a matrix calculation based on prior actions or known consequences. Complex decisions 1060 such as an increasing complexity can be managed with a variety of solutions such as shortest path equations and other forms of optimal estimation as would be well known by one familiar with the art, such as state-space in both continuous and discrete models and recorded as part of the VO learning 908. Correlation with subject matter 1070 in context with a decision may allow further updates to the decision process by applying known rules and standards and lead to and iterative update 1080, where such an iterative update can function as an automated feature in the correlation and weighing of future decisions.

The invention will now be described with reference to specific examples. It will be understood that the following examples are intended to describe embodiments of the invention and are not intended to limit the invention in any way.

### EXAMPLES

### Example 1

A questioner or query profile assigns data to categories based on prior placement of info in categories, their critical nature in a process, baseline history of similar data or query preferences. Sliders in the user interface allow quick association of data with results.

A query might ask a question about a project timeline with an ambiguous completion, such as: “when will you know?” The answer to this query could be based on the probability of certain events, not know to the query VO, yet anticipated by the subject VO. A predictive criteria based on certain events reaching completion would adjust the timeline automatically, but would present the query VO with an answer such as, “presently anticipate six months but we are only 80% confident of certain aspects that may extend the timeline”

As the project proceeds, milestones are met, some which are trivial, and other critical. By weighting the milestones the project can be accessed as to whether it is likely to succeed on time, on budget or even complete at all. The query VO can be contacted based on any changes and lay out the parameters of the project milestones and project how these will look ideally, and then over time in a project sense.

### Example 2

A human query to virtual object based entirely on data. A VO may be a database of sensor values that will have certain criteria that compares it to normal. A query might ask to compare this data to a variety of criteria based on local use preferences. Certain matching criteria are necessary to ensure that the data are providing the sensitivity to local requirements rather than just raw data without any context. These in turn can be weighted by the VO query person based on prior preferences.

### Example 3

Retail products may be listed by their comparison to a database of similar products in a production history or to some standard. A VO query might have little familiarity with such history or standards, so the comparison to these would be of little value. The VO query would like to know if the product in question meets some criteria or combination of criteria specific to their individual needs.

### Example 4

Social media products may create relationships based on user connections. However, a query of certain criteria that enables matching of individual query VO's to a database of other VO query's based on their history of actions, emotions, and vision allow for a comparison of active human attributes that have common origin or personality or work or disposition characteristics in common. Such a VO query might have little interest in certain common characteristics but rather might for instance have specific interest in a area of intellectual inquiry, including its history or standards, and the search by such a VO might extend across the internet to correlate key words and functions. The VO query would like to determine who might have these search criteria in common and wish to share results in such a field of enquiry specific to their individual needs.

### Example 5

An operating system for a smart phone can act as the interface between humans and VO's. A system that would allow a phone that is operated by a person who is indifferent to or unable for any reason to operate a smart phone in a normal manner could enable the potential of such a device to assist this person by having it take advantage of computational methods that would be enabled by emotive responses and learning ability of the user and the system capability to check the perceptive response of the user and employ the iterative capability of the phone computer system or network to further enable an interface that would provide a simplified and even a graphic driven user presentation layer. Furthermore a third party could be engaged to assist the primary user to set up such a phone and could remotely control or update the settings as might be kept in a database environment either on the phone or through a network support system. Such as system can be used to simplify data searches to a presentation layer, or to contextualize data in an emotive, temporal or predictive manner.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method of comparing data sets comprising selectively characterising data according to its use, such that a third party can interpret such data by comparing it to an expected normal state, or to preferred characteristics of a second or n^{th} data set, whereby the methods of reducing data to be represented by an equation allow for rapid assessment of the correlation between data sets, especially as used to correlate human emotional needs in interpreting data.

2. The method of claim 1 whereby the VO space, and its computational database, and presentation layer, provide an opportunity for queries, to connect to the presentation interface, where the query is associated with VO emotion, VO perception, and VO learning, together with the database environment, defining the response history, and summary algorithms further defining event consequences; actions of participants; common perceptions all within a learning environment.

3. The method of claim 1 whereby the a decision is made in context with the complexity, including where a decision is complex yet easier over time, where a decision is more complex over time but reaches a critical point or an indeterminate decision.

4. The method of claim 1 whereby people can equate their questions with their priorities in a timeline, where the expectation of that timeline is correlated to the emotional outcome.

5. The method of comparing data sets whereby interpretation of a correlation between data sets can be optimized to enable display that represents a pattern that can be recognized by a person, or by machine analysis such as a bar code, designed to enhance the communication between people and objects whereby two or more virtual objects which are represented as shape equations including from two to n^{th} order dimensions and the intersection between these virtual objects represents a reduction in the data sets required for analysis including pattern analysis or display in a user interface.

6. The method of claim 5 whereby area specific analysis would allow data comparison of limited form such as would be ideal in assessment of complex parameters, including correlation to coordinates in cartesian space and further used in a time series analysis.

7. The system of claim 5 whereby virtual objects are characterised by their input means in a question and answer environment to allow for generation of best answers to queries summary algorithms, response history and an iterative environment.
